(19) United States
(12) Patent Application Publication
(10) Pub. No.: US 2015/0256399 A1
(43) Pub. Date: Sep. 10, 2015

(54) APPARATUS AND METHOD FOR ZERO-CONFIGURATION INTERWORKING BETWEEN DEVICES, AND DISTRIBUTED HOME NETWORK SYSTEM USING THE SAME

(71) Applicant: Electronics and Telecommunications Research Institute, Daejeon (KR)

(72) Inventors: Hae-Yong KIM, Daejeon (KR); Sang-Cheol KIM, Gyeongsan-si Gyeongsangbuk-do (KR); Seon-Tae KIM, Daejeon (KR)

(21) Appl. No.: 14/635,539

(22) Filed: Mar. 2, 2015

(30) Foreign Application Priority Data
Mar. 4, 2014 (KR) 10-2014-0025487

(51) Int. Cl. H04L 12/24

(52) U.S. Cl. CPC H04L 41/0879

(57) ABSTRACT

Disclosed herein is an apparatus and method for zero-configuration interworking between devices, which solves an expandability problem and does not require a home gateway. The apparatus for zero-configuration interworking between devices includes: an operation mode input unit for receiving an operation mode select signal; a human life standard message generation unit for generating a human life standard message corresponding to the operation mode select signal; a message transmission unit for broadcasting the human life standard message to all other devices in a home; a message reception unit for receiving a human life standard message from the other devices in the home; a setting information storage unit storing information of a preset human life mode; and an operation processing unit for processing an operation corresponding to a human life mode within the received human life standard message, according to the information of the setting information storage unit.

### CROSS REFERENCE TO RELATED APPLICATION

This application claims the benefit of Korean Patent Application No. 10-2014-0025487, filed Mar. 4, 2014, which is hereby incorporated by reference in its entirety into this application.

### BACKGROUND OF THE INVENTION

1. Technical Field

The present invention generally relates to an apparatus and method for zero-configuration interworking between devices, and a distributed home network system using the same. More particularly, the present invention relates to an apparatus and method for zero-configuration interworking between devices, and a distributed home network system using the same, which enable interworking between various devices without a specific configuration in a home network connected by a wired or wireless network.

2. Description of the Related Art

A home network refers one network capable of allowing communication among various home appliances including a TV, a stereo, and the like, wherein the appliances operate in connection with each other. One example is that the volume of a stereo that is connected to a TV is controlled by the TV.

Simply describing a home network, it indicates that devices interwork with each other by exchanging data through various communication methods in a standardized fashion. More specifically, multiple devices establish one network with a home gateway (home server) as the center, and interwork with each other through the network.

Here, generally with the object of home automation, as multiple devices may be controlled by a home gateway, it is possible to control the multiple devices in various ways according to the function of the home gateway. In other words, if the multiple devices are compatible with the home gateway, any service that a user wants may be inserted to the home gateway.

The biggest problem of the current home network described above is that it is difficult to support a new device. Simple connection between devices such as pairing devices using Bluetooth, peer-to-peer media streaming using DLNA, and the like has a simple configuration. Accordingly, when a new device supporting the relative standard is added in the home, a user may use the device in connection with the existing device. However, when a new device is added, it is almost impossible to provide a function of home automation using a home gateway.

A home gateway may obtain information about a new device by accessing the device and provide a controller for controlling the device. However, to provide a new home automation service by connecting the new device to the existing devices, an internal program of the home gateway should be updated. Even if the internal program of the home gateway is designed to enable interworking between various devices through a configuration, due to complexity in the configuration and a number of exceptions and errors that may be caused during the connection between devices, it is difficult for general public to use the new home automation service. Consequently, it is almost impossible to provide an intelligent home automation.

In other words, through standardization, it is possible to obtain information for controlling various functions of diverse new devices and to show a user the information. However, there was no way to include in advance a new device of which the function is unknown in home automation. Also, if the device is a new type of device that has not previously been produced, interworking between devices may be impossible as the functions of the device are not standardized. For example, using a Bluetooth standard, it is possible to connect currently existing devices including a keyboard, a mouse, a speaker, a printer, and the like. However, there is no way to connect a new device, which is not included in the existing Bluetooth profile, using Bluetooth.

Currently, standardization for interworking between devices and for building a home network begins with specifying characteristic functions of each of the devices. These specified functions are recognized by the devices that support the same standard, and it is possible to control each of the devices by explicitly requesting that the device modify a configuration value of a specific function. For example, to control a stereo system, an instruction may be delivered to increase or decrease a value for the function referred to as the volume.

However, as the above mentioned method is available only when each device has a control method for a device to be controlled, there is a limit in expandability. In other words, if it is possible to control the volume of a stereo connected to a TV by transferring a volume control signal from the TV to the stereo, it is because the TV already has had a method for controlling the volume of the stereo. Consequently, even if devices support the same standard, as interworking between the devices is available only when a device has a control method of another device to be controlled, interworking is very limited. In case of a completely new device that has not been specified in a standard, it takes time until a specification of the device is included in the standard. Furthermore, only if each of the existing devices supports a new version of the standard by update, interworking between the new device and the existing devices is possible.

This problem is magnified in providing home automation using a home gateway. The home gateway should know in advance information about all of the connected devices and various functions of each of the devices, and determine how to control each of the devices under a specific condition. Consequently, this home automation may be provided only when information about devices designed to be interworked is understood from the beginning. Also, it is impossible to provide a new service by adding a new device to the already completed home automation or to change an existing device to a new device by adding a new function. For example, for an alarm system connected to a window, a door, and the like, which has been provided at the time of construction of a house, it is impossible to change the alarm system to a new one with a better sensor or to interwork the alarm system with an additional system such as CCTV.

In other words, as illustrated in FIG. 1, in order that an existing home network system provides a proper home automation service, a home gateway 1 should know not only the kinds of devices that can be controlled but also the standard commands for controlling each of the devices.

As described above, the existing home network system has a limit in expandability because a function of each of the devices is directly controlled by the home gateway or another device.

As a related art, Korean Patent Application Publication No. 2012-0057226 (method for providing intelligent home service) discloses providing a convenient and intelligent home service through interworking between a home network and an energy-aware middleware using a smartphone that can minimize comprehensive energy consumption.

As another related art, Korean Patent Application Publication No. 2007-0098032 (home network system and method for implementing dynamic services without Java programming) discloses configuring a new service not using Java programming with OSGi but using dynamic connection information of bundles already installed as basic component bundles and operating the service to be compatible with OSGi standard.

As the other related art, Korean Patent Application Publication No. 2013-0033869 (method and system for association between controller and device in home network) discloses a method and system capable of preventing incorrect association with a device belonging to other home network.

### SUMMARY OF THE INVENTION

Accordingly, the present invention has been made keeping in mind the above problems occurring in the conventional art, and an object of the present invention is to provide an apparatus and method for zero-configuration interworking between devices, and a distributed home network system using the same, which may solve a expandability problem and does not require a home gateway.

In order to accomplish the above object, an apparatus for zero-configuration interworking between devices according to an embodiment of the present invention includes: an operation mode input unit for receiving an operation mode select signal; a human life standard message generation unit for generating, based on the operation mode select signal input by the operation mode input unit, a human life standard message corresponding to the operation mode select signal; a message transmission unit for broadcasting the human life standard message generated by the human life standard message generation unit to all other devices in a home; a message reception unit for receiving a human life standard message transmitted from the other devices in the home; a setting information storage unit for storing information of a preset human life mode; and an operation processing unit for processing, based on a human life mode within the human life standard message received by the message reception unit, an operation corresponding to the human life mode according to the information of the setting information storage unit.

The operation mode input unit may receive the operation mode select signal according to a specific mode that a user personally selects from among various human life modes of a relevant apparatus.

The operation mode select signal may be a signal indicating that any one mode is selected from among a low-noise mode, an outgoing mode, a fire-emergency mode, a sleep mode, a crime prevention mode, an in-room mode, a cooling and heating mode, and a study mode.

The human life standard message indicates a state and demand of a human, which do not change with time, and the human life standard message may include information of any one mode among a low-noise mode, an outgoing mode, a fire-emergency mode, a sleep mode, a crime prevention mode, an in-room mode, a cooling and heating mode, and a study mode.

The human life standard message generated by the human life standard message generation unit may be broadcasted through a network hub.

The apparatus for zero-configuration interworking between devices may further include a control unit for controlling, based on the human life standard message received by the message reception unit, switching to an operation mode corresponding to the human life standard message.

On the other hand, a method for zero-configuration interworking between devices according to an embodiment of the present invention includes: generating, by a human life standard message generation unit, a human life standard message corresponding to an operation mode select signal, based on the received operation mode select signal; and broadcasting, by a message transmission unit, the human life standard message to all other devices in a home.

The method for zero-configuration interworking between devices may further include: receiving, by a message reception unit, a human life standard message transmitted from the other devices in the home; and processing, by an operation processing unit, an operation according to predetermined information, based on a human life mode within the human life standard message.

On the other hand, a distributed home network system according to an embodiment of the present invention includes: a network hub; and a device, connected with other devices through the network hub, including an operation mode input unit for receiving an operation mode select signal, a human life standard message generation unit for generating, based on the operation mode select signal input by the operation mode input unit, a human life standard message corresponding to the operation mode select signal, a message transmission unit for broadcasting the human life standard message generated by the human life standard message generation unit to all other devices in a home, a message reception unit for receiving a human life standard message transmitted from the other devices in the home, a setting information storage unit for storing information of a preset human life mode, and an operation processing unit for processing, based on a human life mode within the human life standard message received by the message reception unit, an operation corresponding to the human life mode according to the information of the setting information storage unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view for illustrating how a conventional home network operates;

FIG. 2 is a block diagram of a distributed home network system according to an embodiment of the present invention;

FIG. 3 is a block diagram illustrating an internal configuration of one of the devices illustrated in FIG. 2;

FIG. 4 is a flow-chart for illustrating a method for zero-configuration interworking between devices according to an embodiment of the present invention; and

FIG. 5 is a view applied to a description of FIG. 4.

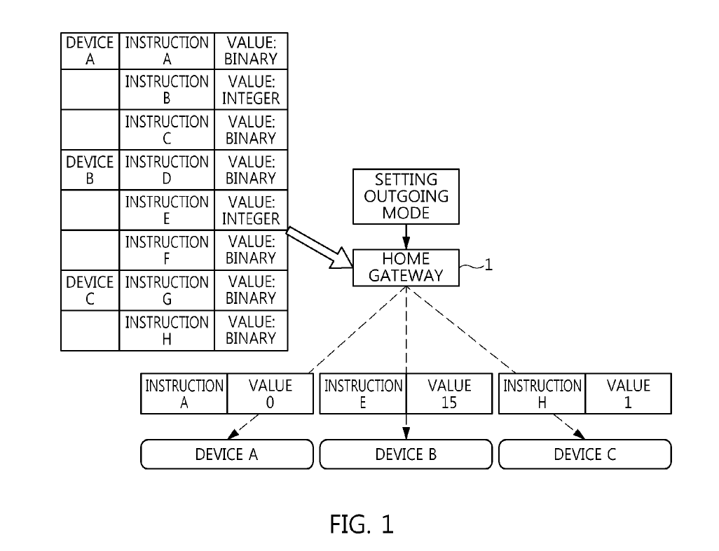

### DESCRIPTION OF THE PREFERRED EMBODIMENTS

The present invention may be variously changed and may have various embodiments, and specific embodiments will be described in detail below with reference to the attached drawings.

However, it should be understood that those embodiments are not intended to limit the present invention to specific disclosure forms and they include all changes, equivalents or modifications included in the spirit and scope of the present invention.

The terms used in the present specification are merely used to describe specific embodiments and are not intended to limit the present invention. A singular expression includes a plural expression unless a description to the contrary is specifically pointed out in context. In the present specification, it should be understood that the terms such as “include” or “have” are merely intended to indicate that features, numbers, steps, operations, components, parts, or combinations thereof are present, and are not intended to exclude a possibility that one or more other features, numbers, steps, operations, components, parts, or combinations thereof will be present or added.

Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not interpreted as being ideal or excessively formal meanings unless they are definitely defined in the present specification.

Embodiments of the present invention will be described in detail with reference to the accompanying drawings. In the following description of the present invention, the same reference numerals are used to designate the same or similar elements throughout the drawings and repeated descriptions of the same components will be omitted.

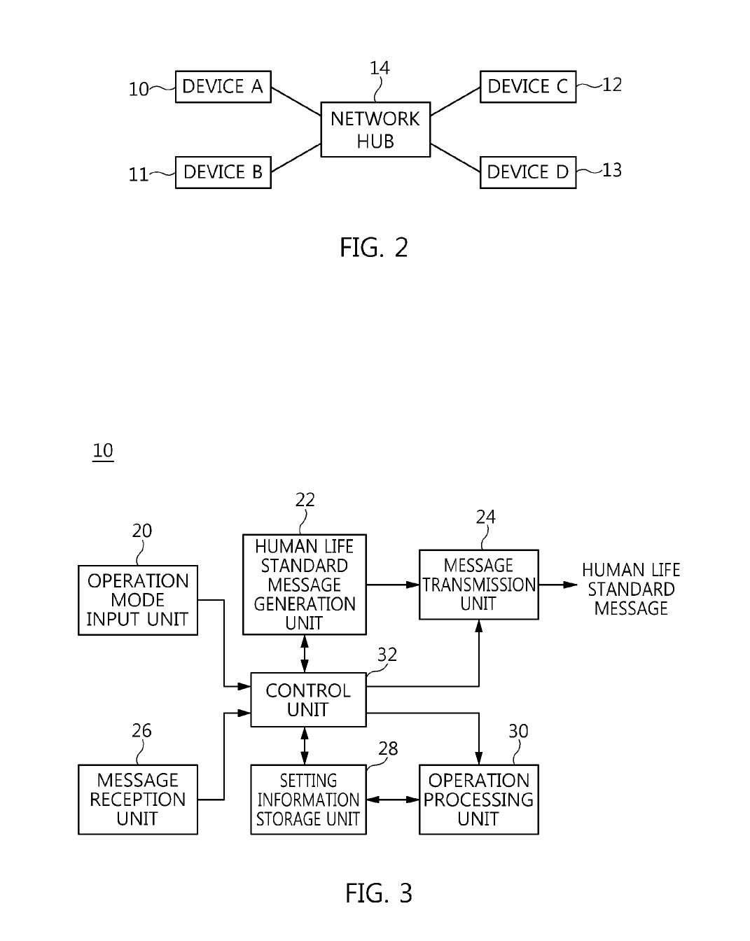

FIG. 2 is a block diagram of a distributed home network system according to an embodiment of the present invention.

Each of household devices 10, 11, 12, and 13 interconnects with each other through a network hub 14. In FIG. 2, four devices are illustrated, but the number of the devices may be more than four.

Data exchanged for interworking between the devices 10, 11, 12, and 13 are not characteristic functions of each of the devices 10, 11, 12, and 13 but messages based on a state/behavior related to a permanent value of a human life (hereinafter referred to as “human life standard message”). Through this human life standard message, the devices 10, 11, 12, and 13 may interwork regardless of an unexpected function of other devices, thus intelligent home automation may be provided.

In other words, for interworking between devices, the devices 10, 11, 12, and 13 exchange only a standardized human life mode message (that is, a human life standard message). According to an instruction of the human life standard message, each of the devices 10, 11, 12, and 13 personally controls its own characteristic and different function, whereby any device may be interworked.

This method enables a new device that has never been produced before to be interworked, and does not require a detailed and complex configuration of a home gateway for interworking. Furthermore, this method may provide a distributed intelligent home automation in which multiple devices interworks without the home gateway.

The above mentioned human life standard message means a state and demand of a human, which has not changed with time. For example, a low-noise mode, an outgoing mode, a fire-emergency mode, a sleep mode, a crime prevention mode, an in-room mode, a cooling and heating mode, a study mode, and the like may be examples of the human life standard message. This human life standard message is related to value that has not changed even though new technology or a new device develops. Accordingly, even a very old device may interwork with a new device so as to provide intelligent home automation.

FIG. 3 is a block diagram illustrating an internal configuration of one of the devices illustrated in FIG. 2. In FIG. 3, an internal configuration of device A 10 is illustrated, but internal configurations of other devices 11, 12, and 13 are the same as that of device A 10. Components illustrated in FIG. 3 may be components of an apparatus for zero-configuration interworking between devices according to an embodiment of the present invention.

Device A 10 includes an operation mode input unit 20, a human life standard message generation unit 22, a message transmission unit 24, a message reception unit 26, a setting information storage unit 28, an operation processing unit 30, and a control unit 32.

The operation mode input unit 20 receives an operation mode select signal as an input. In other words, the operation mode input unit 20 may receive the operation mode select signal according as a user personally selects a specific operation mode among various operation modes of device A 10. For example, the operation modes may include a low-noise mode, an outgoing mode, a fire-emergency mode, a sleep mode, a crime prevention mode, an in-room mode, a cooling and heating mode, a study mode, and the like. The operation mode select signal is a signal indicating that any one mode is selected from among the operation modes mentioned above.

Based on the select signal for a specific operation mode, which is input by the operation mode input unit 20, the human life standard message generation unit 22 generates a human life standard message corresponding to the select signal. For example, the human life standard message may be a message such as “As a low-noise mode is currently set, perform an operation corresponding to the mode”.

Surely, in addition to the human life standard message corresponding to the low-noise mode as mentioned above, the human life standard message generation unit 22 may generate a human life standard message depending on the currently set mode (for example, any one among an outing mode, a fire-emergency mode, a sleep mode, a crime prevention mode, an in-room mode, a cooling and heating mode, and a study mode).

The message transmission unit 24 broadcasts the human life standard message generated by the human life standard message generation unit 22 to other devices 11, 12, and 13 through a network hub 14.

The message reception unit 26 receives the human life standard message transmitted from the other device (any one of device B 11, device C 12, and device D 13).

The setting information storage unit 28 stores information about a human life mode that has been preset in the device (that is, device A 10). In other words, the setting information storage unit 28 stores information of the mode (that is, the human life mode) preset in the device, among the low-noise mode, the outgoing mode, the fire-emergency mode, the sleep mode, the crime prevention mode, the in-room mode, the cooling and heating mode, and the study mode, which are exemplified above. For example, the setting information storage unit 28 may store information indicating that the outgoing mode is preset. Also, when the outgoing mode is set, the setting information storage unit 28 may store information for turning off a television or information for turning on and off the television according to a predetermined cycle.

Based on the human life mode within the human life standard message that is received by the message reception unit 26, the operation processing unit 30 processes an operation corresponding to the human life mode. Here, the human life mode indicates a setting mode included in the human life standard message. For example, when the human life mode within the received human life standard message is a crime prevention mode, the operation processing unit 30 processes an operation of the crime prevention mode preset in the device 10. If the crime prevention mode is not preset in the device 10, the operation processing unit 30 does nothing in response to the message.

The control unit 32 controls operations of the above described components 20, 22, 24, 26, 28, and 30 to enable zero-configuration interworking between devices.

Based on the human life standard message received by the message reception unit 26, the control unit 32 may control switching to an operation mode corresponding to the message. In other words, for example, when the message reception unit 26 receives a human life standard message corresponding to a cooling and heating mode, the control unit 32 controls the device to process an operation in the preset cooling and heating mode. Surely, when a human life standard message corresponding to the cooling and heating mode is received by the message reception unit 26, if the device does not have information set as the cooling and heating mode, even though the control unit 32 switches the mode to a cooling and heating mode, the device will not process an operation of the cooling and heating mode.

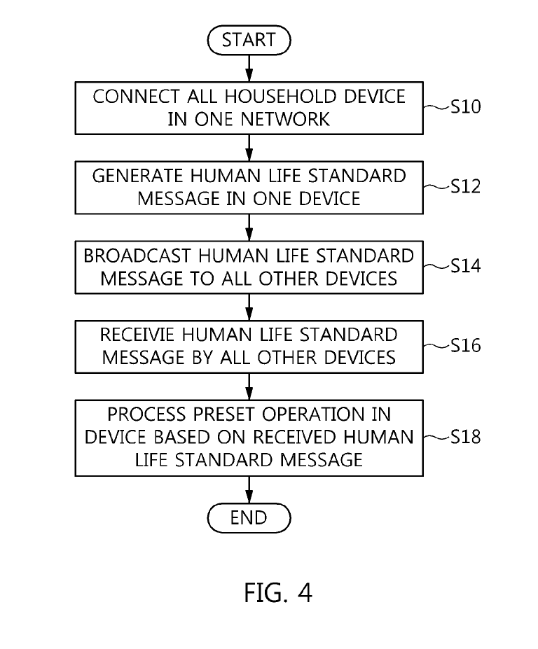

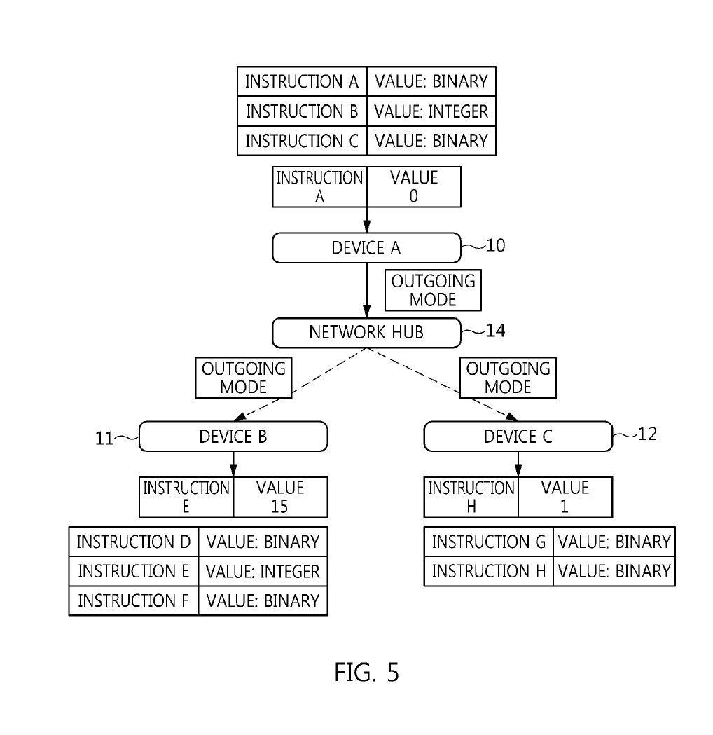

FIG. 4 is a flow-chart for illustrating a method for zero-configuration interworking between devices according to an embodiment of the present invention, and FIG. 5 is a view applied to a description of FIG. 4.

First, various household devices (for example, device A 10, device B 11, device C 12, and device D 13) are connected in one network at step S10. In this case, various wired and wireless communication methods including Ethernet, Wi-Fi, ZigBee, and Bluetooth may be used. These communication methods may be complexly used through a home gateway, but the embodiment of the present invention does not require an intelligent control device for managing a home network, such as the home gateway, and only requires a network hub 14 for simple network connection.

Each of the devices 10, 11, 12, and 13 supports a human life mode standard, and may be configured to the standard. Simply, each of the devices 10, 11, 12, and 13 may participate into/withdraw from home automation by setting on/off of the corresponding standard. In case of a high-end device such as a TV, a detailed configuration may be set for respective modes supported by the device. For example, by setting a time in a crime prevention mode, a TV may be set to operate at a specific time. Here, the configuration is different from that of exist home network systems in that each of the devices 10, 11, 12, and 13 has an individual configuration for its own device rather than a complex configuration for interworking with other devices. Furthermore, generally, it is not necessary to access the configuration. Each of the devices 10, 11, 12, and 13 supports some specific messages related to oneself, among various human life standard messages. For example, if device A 10 is a TV and device B 11 is a stereo, device A 10 and device B 11 do not support human life standard messages such as a fire-emergency mode, an in-room mode, and a cooling and heating mode, and they do nothing in response to the message. If device C 12 is a sprinkler, it supports a human life standard message such as a fire-emergency mode, and responds to the corresponding human life standard message. If device D 13 is a boiler, it supports a human life standard message such as a cooling and heating mode, and responds to the corresponding human life standard message.

As described above, after all of the household devices 10, 11, 12, and 13 are connected in a network, for example, when one device (for example, device A 10 in FIG. 5) generates a human life standard message corresponding to an outgoing mode at step S12, the device broadcasts the generated human life standard message to all of the other devices at step S14. Surely, device B 11, device C 12, or device D 13 may generate a specific human life standard message and broadcast it, instead of device A 10. In other words, the human life standard message of the outgoing mode is broadcasted to the other devices 11, 12, and 13 in a home network through a network hub 14.

Accordingly, each of the devices 11, 12, and 13 receives the human life standard message of the outgoing mode from device A 10 at step S16.

Subsequently, each of the devices 11, 12, and 13 processes a proper operation using its own various functions at step S18. Here, the difference from existing home network systems is that instead of an individual message for instructing each of the devices to process a specific function, the same human life standard message is delivered to all of the devices. Then, change of a state and a function that each device will operate are autonomously performed depending on a configuration of a manufacturer or a user of the device. Consequently, even if a new function is inserted to each device, or a completely new device is added in a home network, the device is interworked through the home network and may participate for provision of a home automation service. For example, as a previously used TV supports only an outgoing mode, the TV is automatically turned off when receiving a human life standard message corresponding to the outgoing mode. On the other hand, after replacing the TV with a TV in which a recording function is inserted, a function for recording a specific program when an outgoing mode is set may be added, the specific program being selected by a user. Also, after replacing the TV with a TV in which a crime prevention mode is additionally supported, the TV may be automatically operated at a specific time responding to reception of a human life standard message corresponding to the crime prevention mode. Additionally, when buying a robotic vacuum cleaner that has not been in the house, the robotic vacuum cleaner may automatically participate in home automation and start cleaning in response to reception of a human life standard message corresponding to an outgoing mode.

As described above, home automation using a human life standard message may be used in two ways. The first way is that a user directly requests for switching to a relevant mode so that multiple devices operate their own functions corresponding to the mode. The second way is that a user changes a state of a specific device or a specific device automatically transmits a specific human life standard message, whereby other multiple devices are switched to the specific mode. In the former occasion, according to a value explicitly set by a user, all devices are switched to a relevant mode, and a human life standard message is generally broadcasted by devices including a smartphone. In the latter occasion, for example, when a user operates a cooling apparatus, a human life standard message corresponding to a cooling and heating mode is automatically transmitted, and windows and doors receiving the message are closed, or when a fire detection sensor detects a fire and transmits a human life standard message corresponding to a fire-emergency mode, a sprinkler operates, gas is shut off, and windows and a front door are opened.

According to the present invention as configured above, to build a home network and to provide a home automation service through the network, standard messages related to a human life are exchanged, rather than specifications about detailed functions of each device. Also, control of the detailed functions and states is personally performed by each device according to the standard messages. Consequently, it is possible to build a home network without a specific configuration, whereby a home automation service with high expandability may be provided.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. An apparatus for zero-configuration interworking between devices, comprising:
an operation mode input unit for receiving an operation mode select signal;
a human life standard message generation unit for generating, based on the operation mode select signal input by the operation mode input unit, a human life standard message corresponding to the operation mode select signal;
a message transmission unit for broadcasting the human life standard message generated by the human life standard message generation unit to all other devices in a home;
a message reception unit for receiving a human life standard message transmitted from the other devices in the home;
a setting information storage unit for storing information of a preset human life mode; and
an operation processing unit for processing, based on a human life mode within the human life standard message received by the message reception unit, an operation corresponding to the human life mode according to the information of the setting information storage unit.

2. The apparatus of claim 1, wherein the operation mode input unit receives the operation mode select signal according to a specific mode that a user personally selects from among various human life modes of a relevant apparatus.

3. The apparatus of claim 1, wherein the operation mode select signal is a signal indicating that any one mode is selected from among a low-noise mode, an outgoing mode, a fire-emergency mode, a sleep mode, a crime prevention mode, an in-room mode, a cooling and heating mode, and a study mode.

4. The apparatus of claim 1, wherein the human life standard message indicates a state and demand of a human, which do not change with time, and the human life standard message includes information of any one mode among a low-noise mode, an outgoing mode, a fire-emergency mode, a sleep mode, a crime prevention mode, an in-room mode, a cooling and heating mode, and a study mode.

5. The apparatus of claim 1, wherein the human life standard message generated by the human life standard message generation unit is broadcasted through a network hub.

6. The apparatus of claim 1, further comprising,
a control unit for controlling, based on the human life standard message received by the message reception unit, switching to an operation mode corresponding to the human life standard message.

7. A method for zero-configuration interworking between devices, comprising:
generating, by a human life standard message generation unit, a human life standard message corresponding to an operation mode select signal, based on the received operation mode select signal; and
broadcasting, by a message transmission unit, the human life standard message to all other devices in a home.

8. The method of claim 7, wherein the operation mode select signal is a signal generated according as a user personally selects a specific mode among various human life modes.

9. The method of claim 7, wherein the operation mode select signal is a signal indicating that any one mode is selected from among a low-noise mode, an outgoing mode, a fire-emergency mode, a sleep mode, a crime prevention mode, an in-room mode, a cooling and heating mode, and a study mode.

10. The method of claim 7, wherein the human life standard message indicates a state and demand of a human, which do not change with time, and the human life standard message includes information of any one mode among a low-noise mode, an outgoing mode, a fire-emergency mode, a sleep mode, a crime prevention mode, an in-room mode, a cooling and heating mode, and a study mode.

11. The method of claim 7, wherein in broadcasting the human life standard message, the human life standard message is broadcasted through a network hub.

12. The method of claim 7, further comprising:
receiving, by a message reception unit, a human life standard message transmitted from the other devices in the home; and
processing, by an operation processing unit, an operation according to predetermined information, based on a human life mode within the human life standard message.

13. A distributed home network system, comprising:
a network hub; and
a device, connected with other devices through the network hub, including an operation mode input unit for receiving an operation mode select signal, a human life standard message generation unit for generating, based on the operation mode select signal input by the operation mode input unit, a human life standard message corresponding to the operation mode select signal, a message transmission unit for broadcasting the human life standard message generated by the human life standard message generation unit to all other devices in a home, a message reception unit for receiving a human life standard message transmitted from the other devices in the home, a setting information storage unit for storing information of a preset human life mode, and an operation processing unit for processing, based on a human life mode within the human life standard message received by the message reception unit, an operation corresponding to the human life mode according to the information of the setting information storage unit.

14. The distributed home network system of claim 13, wherein the operation mode input unit receives the operation mode select signal according to a specific mode that a user personally selects from among various human life modes of a relevant device.

15. The distributed home network system of claim 13, wherein the operation mode select signal is a signal indicating that any one mode is selected from among a low-noise mode, an outgoing mode, a fire-emergency mode, a sleep mode, a crime prevention mode, an in-room mode, a cooling and heating mode, and a study mode.

16. The distributed home network system of claim 13, wherein the human life standard message indicates a state and demand of a human, which do not change with time, and the human life standard message includes information of any one mode among a low-noise mode, an outgoing mode, a fire-emergency mode, a sleep mode, a crime prevention mode, an in-room mode, a cooling and heating mode, and a study mode.

17. The distributed home network system of claim 13, wherein the device further comprises a control unit for controlling, based on the human life standard message received by the message reception unit, switching to an operation mode corresponding to the human life standard message.
